(19) United States
(12) Patent Application Publication
(10) Pub. No.: US 2004/0111721 A1
(43) Pub. Date: Jun. 10, 2004

(54) Method for branch slamming as a safe mechanism for binary code editing

(75) Inventor: Jan Civlin, Sunnyvale, CA (US)

Correspondence Address: MARTINE & PENILLA, LLP, 710 LAKEWAY DRIVE, SUITE 170, SUNNYVALE, CA, 94085, US

(73) Assignee: Sun Microsystems, Inc., Santa Clara, CA

(21) Appl. No.: 10/315,968

(22) Filed: Dec. 9, 2002

(51) Int. Cl. G06F 9/445

(52) U.S. Cl. 717/168

(57) ABSTRACT

A method is provided for safely editing a binary code to be executed on a computer system. Broadly speaking, the method allows a binary code to be directly edited without compromising its integrity. The method provides for using a branch slamming operation to displace a binary instruction contained within the binary code with a branch to a binary patch. The binary instruction displaced by the branch is preserved in the binary patch. Upon completion of the binary patch execution, the binary code continues its execution with a binary instruction immediately following the branch. The method also provides for use of multiple branches and multiple binary patches to edit the binary code.

### CROSS REFERENCE TO RELATED APPLICATIONS

This application is related to U.S. patent application Ser. No. ______ (Attorney Docket No. SUNMP137), filed Dec. 9, 2002, and entitled “Method for Safely Instrumenting Large Binary Code,” which is incorporated herein by reference.

### BACKGROUND OF THE INVENTION

1. Field of the Invention

The present invention relates generally to a computer system, and more particularly, to a method for editing binary code used to operate the computer system.

2. Description of the Related Art

In general, computer systems are controlled by computer programs. Computer programs may be developed using a number of different programming languages. The number of different programming languages can be sorted into at least three classifications: high-level, low-level, and machine.

High-level programming languages (e.g., C, C++, Java, etc . . . ) allow programs to be developed that are more or less independent of a particular computer system on which the programs will execute. High-level programming languages are also easier to read, write, and maintain. However, a program written in a high-level language must be translated into a machine language before it can be executed. Translation of the high-level language into the machine language can be performed by either a compiler or an interpreter.

As compared to the high-level language, a low-level language is closer to the machine language necessary for execution of the program. A low-level language contains the same instructions as the machine language, but the instructions and variables are identified by names rather than only numbers. Thus, low-level languages are more readily understood than machine languages. Assembly languages are classified as low-level languages. An assembler program is used to translate assembly language programs into machine language.

Machine languages consist entirely of numbers and are the only languages understood by a computer system. Machine languages are actually sequences of binary instructions consisting of bits (i.e., 0's and 1's). Thus, machine languages are often referred to as binary codes. Machine languages actually control the computer system circuitry. Each type of computer system has its own unique circuitry. Therefore, each type of computer system has its own unique machine language. To be executable by a computer system, every program must be translated into the machine language that the computer system understands.

Binary codes (i.e., machine languages) are easily understood and implemented by computer systems, but are nearly impossible for people to understand and use. However, there are situations when it is necessary for people to work directly with and modify binary codes. In these situations, an original source code (i.e., high-level language version of the program) is usually not available and only a portion of the binary code may actually be understood. A modification or edit of the binary code should be performed in a manner that maintains the binary code's integrity. Otherwise, the binary code may become non-executable or executable with errors.

In view of the foregoing, there is a need for a method for safely editing a binary code to be executed on a computer system. The method should ensure the integrity of the binary code to maintain its proper execution while preventing potentially damaging errors.

### SUMMARY OF THE INVENTION

Broadly speaking, the present invention fills these needs by providing a method for safely editing a binary code to be executed on a computer system. The present invention allows a binary code to be directly edited without compromising its integrity. The method provides for using a branch slamming operation to displace a binary instruction contained within the binary code with a branch to a binary patch. The binary instruction displaced by the branch is preserved in the binary patch. Upon completion of the binary patch execution, the binary code continues executing with a binary instruction immediately following the branch. It should be appreciated that the present invention can be implemented in numerous ways, including as a process, an apparatus, a system, a device, or a method. Several embodiments of the present invention are described below.

In one embodiment, a method for editing a binary code is disclosed. The method includes preparing a binary patch that contains supplemental instructions to be included in the binary code. The method also includes identifying an instruction in the binary code and replacing the instruction with a branch. The branch directs a control of the binary code to the binary patch.

In another embodiment, a method for inserting a binary patch into a binary code is disclosed. The method includes identifying a first instruction in the binary code to be replaced by a branch to the binary patch. The branch directs a program control to an initial instruction in the binary patch. The method further includes preparing the binary patch. The binary patch contains supplemental instructions to be included in the binary code. The initial instruction in the binary patch is the first instruction in the binary code to be replaced by the branch. A final instruction in the binary patch directs the program control to a second instruction in the binary code. The second instruction immediately follows the first instruction in the binary code that is to be replaced by the branch. The method also includes replacing the first instruction in the binary code with the branch.

In another embodiment, a method for inserting a plurality of binary patches into a binary code is disclosed. The method includes identifying a plurality of instructions in the binary code to be replaced by a plurality of branches. The plurality of instructions occur sequentially in the binary code. The plurality of branches correspond to a plurality of binary patches. A first instruction of the plurality of instructions directs a program control to an initial instruction in a first binary patch. The first binary patch is one of the plurality of binary patches. The method further includes preparing the plurality of binary patches. The plurality of binary patches contain supplemental instructions to be included in the binary code. The initial instruction in the first binary patch is the first instruction of the plurality of instructions in the binary code to be replaced by the plurality of branches. A final instruction in each of the plurality of binary patches directs the program control to an initial instruction in a subsequent binary patch. The initial instruction in a subsequent binary patch is a subsequent instruction in the plurality of instructions in the binary code to be replaced by the plurality of branches. A final instruction in a last binary patch of the plurality of binary patches directs the program control to an instruction in the binary code that immediately follows the plurality of instructions to be replaced by the plurality of branches. The method also includes replacing each of the plurality of instructions in the binary code with one of the plurality of branches.

In another embodiment, a method for inserting two binary patches into a binary code is disclosed. The method includes identifying a first instruction in the binary code to be replaced by a first branch. The first branch corresponds to a first binary patch and directs a program control to an initial instruction in the first binary patch. The method also includes identifying a second instruction in the binary code to be replaced by a second branch. The second instruction immediately follows the first instruction in the binary code. The second branch corresponds to a second binary patch. The method further includes preparing the first binary patch. The first binary patch contains supplemental instructions to be included in the binary code. The initial instruction in the first binary patch is the first instruction in the binary code to be replaced by the first branch. A final instruction in the first binary patch directs the program control to an initial instruction in the second binary patch. The method further includes preparing the second binary patch. The second binary patch also contains supplemental instructions to be included in the binary code. The initial instruction in the second binary patch is the second instruction in the binary code to be replaced by the second branch. A final instruction in the second binary patch directs the program control to an instruction in the binary code immediately following the second instruction that is replaced by the second branch. The method also includes replacing the first and second instructions in the binary code with the first and second branches, respectively.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a binary code, in accordance with an exemplary embodiment of the present invention;

FIG. 2 is an illustration showing a branch slamming operation, in accordance with an exemplary embodiment of the present invention;

FIG. 3 is an illustration showing a branch slamming operation incorporating two successive branches, in accordance with an exemplary embodiment of the present invention;

FIG. 4 is an illustration showing a branch slamming operation incorporating a number successive branches, in accordance with an exemplary embodiment of the present invention;

FIG. 5 shows a flowchart illustrating a method for editing a binary code, in accordance with one embodiment of the present invention;

FIG. 6 shows a flowchart illustrating a method for inserting a binary patch into a binary code, in accordance with one embodiment of the present invention;

FIG. 7 shows a flowchart illustrating a method for inserting two binary patches into a binary code, in accordance with one embodiment of the present invention; and

FIG. 8 shows a flowchart illustrating a method for inserting a plurality binary patches into a binary code, in accordance with one embodiment of the present invention.

### DETAILED DESCRIPTION OF THE PREFERRED EMBODIMENTS

An invention is disclosed for a method for safely editing a binary code to be executed on a computer system. Broadly speaking, the present invention allows the binary code to be directly edited without compromising its integrity. The method provides for using a branch slamming operation to displace a binary instruction contained within the binary code with a branch to a binary patch. The binary instruction displaced by the branch is preserved in the binary patch. Upon completion of the binary patch execution, the binary code continues executing with an instruction immediately following the branch. The binary code integrity is maintained by preserving a machine state immediately prior to the branch.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

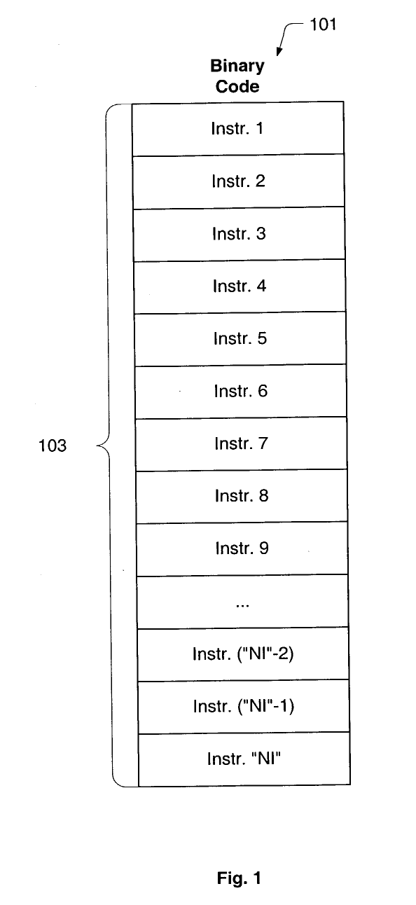

FIG. 1 is an illustration showing a binary code 101, in accordance with an exemplary embodiment of the present invention. The binary code 101 includes a number of instructions 103. The number of instructions 103 is a contiguous sequence of instructions extending from a first instruction, Instr. 1, to a final instruction, Instr. “NI”, where “NI” represents a total number of instructions in the binary code.

An occasion may arise in which the binary code 101 needs to be directly modified. A direct modification of the binary code 101 may constitute replacement of one or many instructions. For example, there may be a desire to insert instructions to facilitate debugging. In a further example, there may be a desire to insert instructions to optimize a portion of the binary code 101. However, direct modification of the binary code 101 can be difficult and prone to introduce errors.

Some instructions in the binary code 101 represent data while other instructions control a program flow. For example, a branch instruction controls the program flow by directing execution of the binary code 101 to continue with a target instruction located elsewhere in the binary code 101. If the portion of binary code 101 to be modified contains such target instructions, modification of the binary code 101 may cause the associated branch instructions to direct execution of the binary code 101 to erroneous target instructions. If such target instructions are known, however, they can be modified to avoid errors. Unfortunately, the entire content of the binary code 101 is generally not known when directly performing binary code 101 modifications. Thus, a potential exists for unknown branch instructions somewhere in the binary code 101 to correspond to target instructions in the portion of binary code 101 being modified. Hence, there is a need for a method for safely editing the binary code 101 that avoids disrupting such unknown branch instructions.

A standard procedure for modifying the binary code 101 is to modify an original source code used to create the binary code 101 and recompile the original source code. However, there are occasions when the original source code is not available to one needing to modify the binary code 101. It is also not possible to simply spread previously existing instructions in the binary code 101 apart to make space available for instructions required by the modification. Such a rearrangement of previously existing instructions would likely render the binary code 101 inoperable. Thus, the modification must be implemented while maintaining the integrity of the binary code 101. A branch slamming operation as disclosed by the present invention can be used to directly and safely modify the binary code 101 while maintaining its integrity.

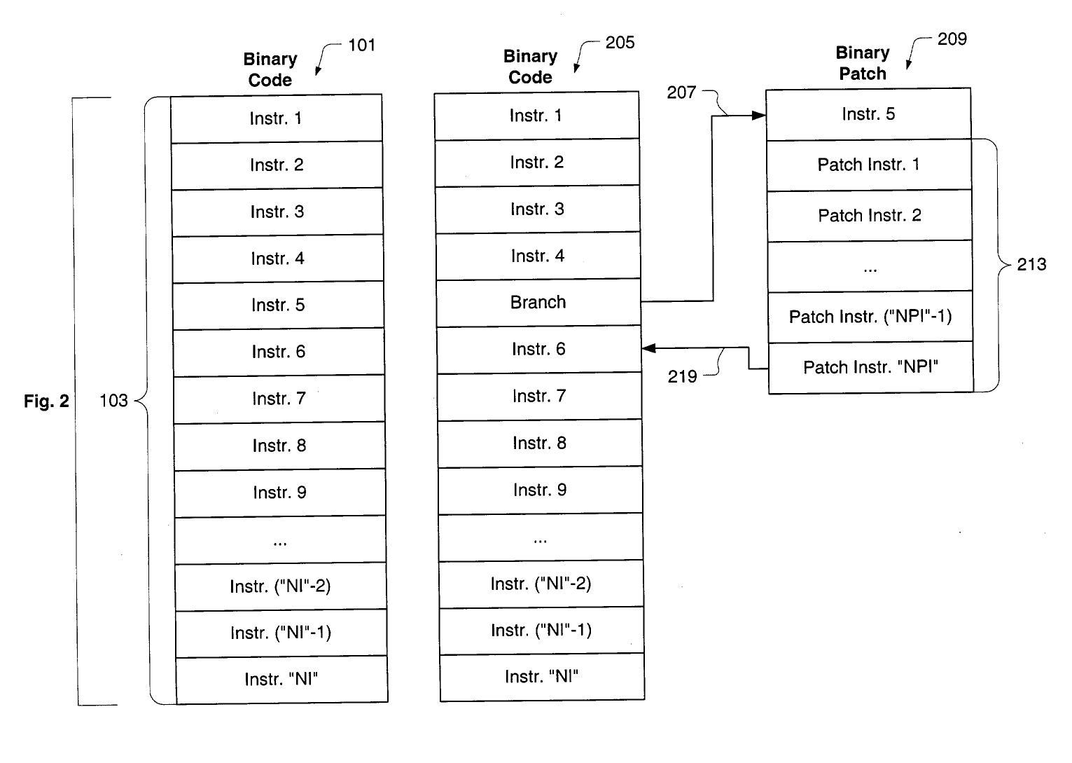

FIG. 2 is an illustration showing the branch slamming operation, in accordance with an exemplary embodiment of the present invention. The binary code 101 including the number of instructions 103 extending from Instr. 1 to Instr. “NI” is shown. A modified binary code 205 is also shown. The modified binary code 205 includes the same number of instructions 103 as the binary code 101. However, an instruction, Instr. 5, has been replaced by a branch instruction, Branch. The replacement of Instr. 5 with the Branch is an example what is termed branch slamming. Other instructions in the modified binary code 205 remain the same as in the binary code 101.

Binary codes (e.g., the binary code 101 and the modified binary code 205) have a program control to execute their instructions in a particular sequence. In general, a default for the program control is to execute instructions in the order in which they occur. However, the program control can also be directed by the instructions as they are executed. The Branch in the modified binary code 205 directs the program control to a binary patch 209 as indicated by an arrow 207.

A first instruction in the binary patch 209 is the instruction from the binary code 101 that was replaced by the Branch to create the modified binary code 205. In the example of FIG. 2, Instr. 5 is the first instruction in the binary patch 209 as it was the instruction in the binary code 101 replaced by the Branch to create the modified binary code 205. In the branch slamming operation, the instruction replaced by the Branch does not itself direct or redirect the program control. A load instruction and a store instruction are examples of instructions which do not direct or redirect the program control. As the load and store instructions are provided as examples, other instructions that do not direct or redirect the program control may also be replaced by the Branch to effect the branch slamming operation.

With respect to the example of FIG. 2, Instr. 5 does not direct or redirect the program control. Thus, in the binary code 101, the program control will continue by executing an instruction, Instr. 6, immediately following execution of Instr. 5. In following, after execution of Instr. 5 in the binary patch 209, the program control will continue by executing an instruction immediately following Instr. 5 in the binary patch 209. Hence, the binary patch 209 includes Instr. 5 followed by a number of patch instructions 213. The number of patch instructions 213 is a contiguous sequence of instructions extending from a first patch instruction, Patch Instr. 1, to a final patch instruction, Patch Instr. “NPI”, where “NPI” represents a total number of patch instructions. The total number of patch instructions can be one or more instructions necessary for the binary patch 209 to perform a desired function. The final patch instruction directs the program control to execute the instruction immediately following the branch in the modified binary code 205 as indicated by an arrow 219. The program control then proceeds to execute the remainder of the modified binary code 205.

The branch slamming operation must be performed in a manner that preserves the integrity of the binary code 101. The integrity of the binary code 101 is preserved by preserving a machine state that exists prior to execution of the branch instruction. Thus, upon return of the program control from the binary patch 209, the binary code 101 will continue to execute as if the binary patch 209 was not present. Also, at least one instruction in the binary code 101 must be known to implement the branch slamming operation. In general, it is not necessary to know or understand other aspects of the binary code 101 beyond those involved in the branch slamming operation.

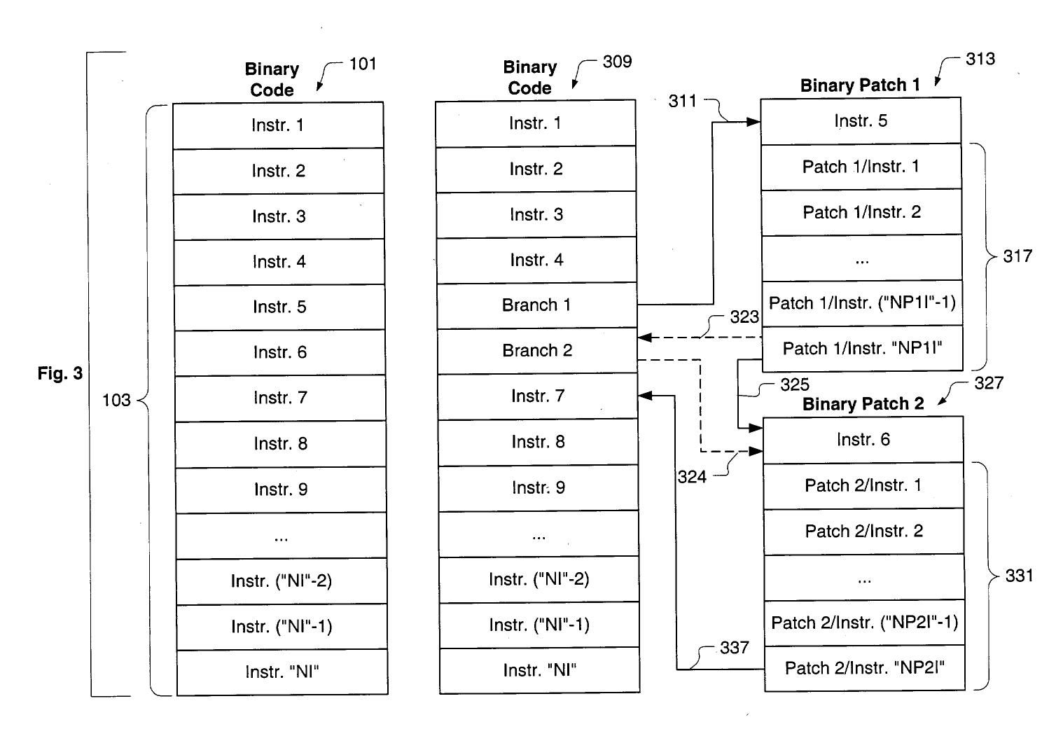

FIG. 3 is an illustration showing a branch slamming operation incorporating two successive branches, in accordance with an exemplary embodiment of the present invention. The binary code 101 including the number of instructions 103 extending from Instr. 1 to Instr. “NI” is shown. A modified binary code 309 is also shown. The modified binary code 309 includes the same number of instructions 103 as the binary code 101. However, an instruction, Instr. 5 has been replaced by a first branch, Branch 1. Similarly, an instruction, Instr. 6, has been replaced by a second branch, Branch 2. Thus, the replacement of Instr. 5 and Instr. 6 with Branch 1 and Branch 2, respectively, represents the branch slamming operation incorporating two successive branches. Other instructions in the modified binary code 309 remain the same as in the binary code 101.

Branch 1 in the modified binary code 309 directs the program control to a first binary patch 313 as indicated by an arrow 311. A first instruction in the first binary patch 313 is Instr. 5 from the binary code 101 that was replaced by Branch 1. With respect to the example of FIG. 3, Instr. 5 does not direct or redirect the program control. Thus, after execution of Instr. 5 in the first binary patch 313, the program control directs the execution of an instruction immediately following Instr. 5 in the first binary patch 313. Hence, the first binary patch 313 includes Instr. 5 followed by a number of first patch instructions 317.

The number of first patch instructions 317 is a contiguous sequence of instructions extending from a first patch instruction, Patch 1/Instr. 1, to a final patch instruction, Patch 1/Instr. “NP1I”, where “NP1I” represents a total number of first patch instructions. The final patch instruction generally directs the program control to execute the instruction immediately following Branch 1 in the modified binary code 309 as indicated by an arrow 323.

The instruction immediately following Branch 1 in the modified binary code 309 is Branch 2. Branch 2 directs the program control to a second binary patch 327 as indicated by an arrow 324. Since Branch 1 and Branch 2 occur successively in the modified binary code 309, the program control can be optimized by defining the final patch instruction, Patch 1/Instr. “NP1I”, of the first binary patch 313 to direct the program control to the second binary patch 327 as indicated by an arrow 325.

A first instruction in the second binary patch 327 is Instr. 6 from the binary code 101 that was replaced by Branch 2. With respect to the example of FIG. 3, Instr. 6 does not direct or redirect the program control. Thus, after execution of Instr. 6 in the second binary patch 327, the program control directs the execution of an instruction immediately following Instr. 6 in the second binary patch 327. Hence, the second binary patch 327 includes Instr. 6 followed by a number of second patch instructions 331.

The number of second patch instructions 331 is a contiguous sequence of instructions extending from a first patch instruction, Patch 2/Instr. 1, to a final patch instruction, Patch 2/Instr. “NP2I”, where “NP2I” represents a total number of second patch instructions. The final patch instruction directs the program control to execute the instruction immediately following Branch 2 in the modified binary code 309 as indicated by an arrow 337. The program control then proceeds to execute the remainder of the modified binary code 309.

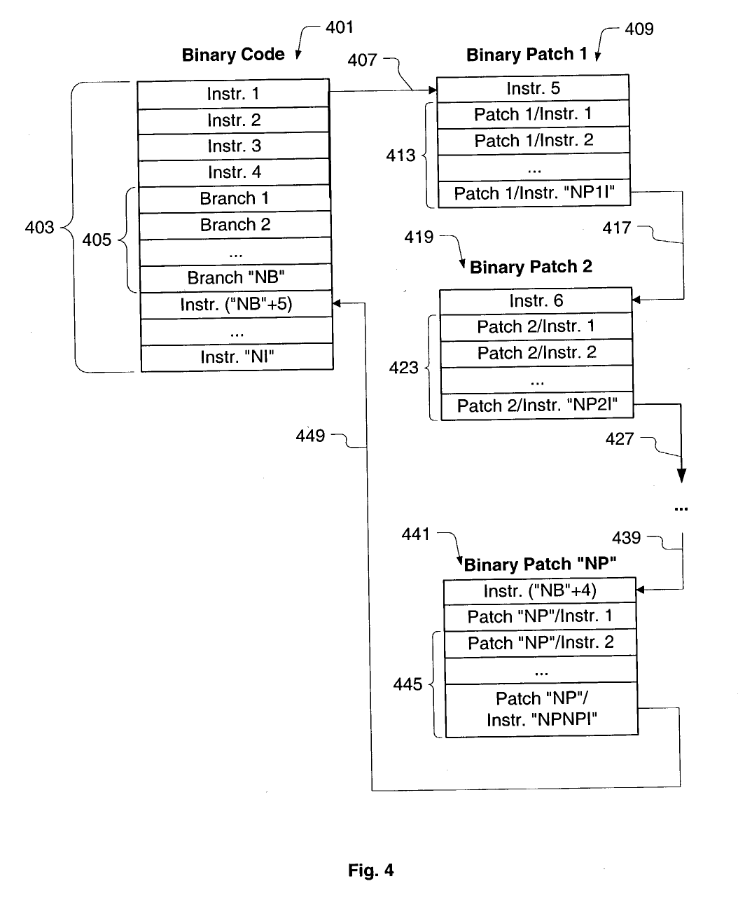

FIG. 4 is an illustration showing a branch slamming operation incorporating a number of successive branches, in accordance with an exemplary embodiment of the present invention. A modified binary code 401 including a number of instructions 403 extending from Instr. 1 to Instr. “NI” is shown, where “NI” represents a total number of instructions. A number of instructions following an instruction, Instr. 4, are replaced by a number of successive branches 405. The number of successive branches 405 extends from a first branch, Branch 1, to a final branch, Branch “NB”, where “NB” represents a total number of branches. Branch 1 in the modified binary code 401 directs the program control to a first binary patch 409 as indicated by an arrow 407.

A first instruction in the first binary patch 409 is Instr. 5 from the modified binary code 401 that was replaced by Branch 1. With respect to the example of FIG. 4, Instr. 5 does not direct or redirect the program control. Thus, after execution of Instr. 5 in the first binary patch 409, the program control directs the execution of an instruction immediately following Instr. 5 in the first binary patch 409. Hence, the first binary patch 409 includes Instr. 5 followed by a number of first patch instructions 413. The number of first patch instructions 413 is a contiguous sequence of instructions extending from a first patch instruction, Patch 1/Instr. 1, to a final patch instruction, Patch 1/Instr. “NP1I”, where “NP1I” represents a total number of first patch instructions. The final patch instruction, Patch 1/Instr. “NP1I”, directs the program control to a second binary patch 419 as indicated by an arrow 417.

A first instruction in the second binary patch 419 is Instr. 6 from the modified binary code 401 that was replaced by Branch 2. With respect to the example of FIG. 4, Instr. 6 does not direct or redirect the program control. Thus, after execution of Instr. 6 in the second binary patch 419, the program control directs the execution of an instruction immediately following Instr. 6 in the second binary patch 419. Hence, the second binary patch 419 includes Instr. 6 followed by a number of second patch instructions 423. The number of second patch instructions 423 is a contiguous sequence of instructions extending from a first patch instruction, Patch 2/Instr. 1, to a final patch instruction, Patch 2/Instr. “NP2I”, where “NP2I” represents a total number of second patch instructions. The final patch instruction directs the program control to execute a first instruction in a subsequently occurring patch as indicated by an arrow 427.

The subsequently occurring patch corresponds to a subsequently occurring branch in the modified binary code 401. The program control proceeds with execution of the subsequently occurring patch. The final patch instruction in the subsequently occurring patch directs the program control to execute a first instruction in yet another subsequently occurring patch. This process continues until the program control is directed to a first instruction in a final binary patch 441, as indicated by an arrow 439.

For purposes of illustration in FIG. 4, the final binary patch 441 is designated as Binary Patch “NP”, where “NP” represents a total number of binary patches. The total number of binary patches is equivalent to the total number of branches (i.e., “NP” “NB”). As with the previously occurring binary patches, a first instruction in the final binary patch 441 corresponds to an instruction, Instr. (“NB”+4), in the modified binary code 401 that was replaced by the final branch, Branch “NB”, associated with the final binary patch 441. With respect to the example of FIG. 4, Instr. (“NB”+4) does not direct or redirect the program control. Thus, after execution of Instr. (“NB”+4) in the final binary patch 441, the program control directs the execution of an instruction immediately following Instr. (“NB”+4) in the final binary patch 441. Hence, the final binary patch 441 includes Instr. (“NB”+4) followed by a number of final patch instructions 445. The number of final patch instructions 445 is a contiguous sequence of instructions extending from a first patch instruction, Patch “NP”/Instr. 1, to a final patch instruction, Patch “NP”/Instr. “NPNPI”, where “NPNPI” represents a total number of final patch instructions. The final patch instruction, Patch “NP”/Instr. “NPNPI”, directs the program control to execute the instruction immediately following the final branch, Branch “NB”, in the modified binary code 401 as indicated by an arrow 449. The program control then proceeds to execute the remainder of the modified binary code 401.

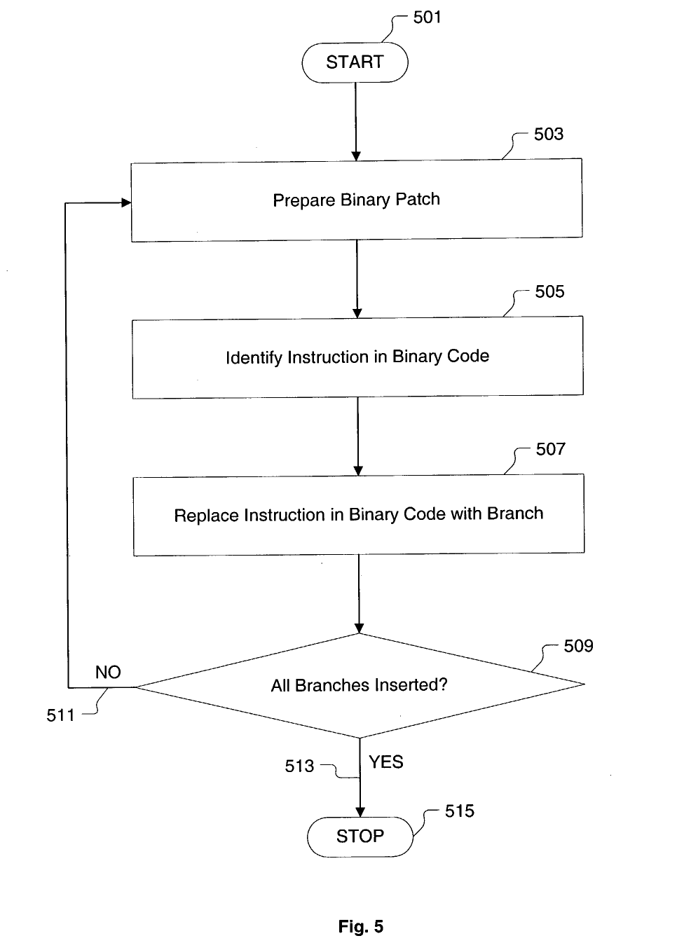

FIG. 5 shows a flowchart illustrating a method for editing a binary code, in accordance with one embodiment of the present invention. The method begins at a start block 501. The method includes an operation 503 for preparing a binary patch. The binary patch contains supplemental instructions to be included in the binary code. The method further includes an operation 505 for identifying an instruction in the binary code. The identified instruction is one of a plurality of binary instructions included in the binary code. The plurality of binary instructions are executable by circuitry of a computer system. Thus, the binary code is represented using a machine language that is a native language for an architecture defining the circuitry of the computer system. The method further includes an operation 507 for replacing the instruction in the binary code with a branch. The branch directs a control of the binary code to the binary patch.

In one embodiment, the instruction in the binary code is replaced by the branch without recompiling an original source code, wherein the original source code was used to create the binary code. The instruction in the binary code is also replaced by the branch while preserving a machine state that is present immediately prior to the replacement. The machine state includes the values associated with a plurality of registers and other data existing within the computer system. The instruction in the binary code replaced by the branch is specified as a first instruction in the binary patch corresponding to the branch. A last instruction in the binary patch directs the control of the binary code to a subsequent instruction in the binary code, wherein the subsequent instruction in the binary code immediately follows the instruction replaced by the branch.

The method further includes a decision operation 509 for determining whether all branches have been inserted into the binary code. If the decision operation 509 determines that all branches have been inserted into the binary code, the method ends at a stop block 515, as indicated by an arrow 513. If the decision operation 509 determines that all branches have not been inserted into the binary code, the method loops back to the operation 503 for preparing the binary patch, as indicated by an arrow 511. The method then continues through operations 505 and 507 until the decision operation 509 is reached again and reperformed.

Therefore, in one embodiment the method includes preparing a number of additional binary patches, wherein each additional binary patch contains supplemental instructions to be included in the binary code. This embodiment of the method also includes identifying a number of additional instructions in the binary code and replacing each of the additional instructions in the binary code with one of a number of additional branches. Each of the number of additional branches directs the control of the binary code to one of the number of additional binary patches. The number of additional instructions replaced by the number of additional branches are consecutive instructions in the binary code. Each of the number of additional binary patches includes a first instruction corresponding to one of the number of additional instructions replaced by the number of additional branches. Each of the number of additional binary patches also includes a last instruction which directs the control of the binary code to the first instruction in a subsequent binary patch. The additional binary patches are sequenced such that their respective first instructions correspond to an original sequence of the number of additional instructions replaced by the number of additional branches. A final instruction in a last of the additional binary patches directs the control of the binary code to an instruction immediately following a last of the additional branches. Replacement of each of the number of additional instructions by one of the number of additional branches is performed such that the machine state is preserved.

In another embodiment, the method for editing the binary code can be performed by disassembling the machine language to represent the binary code in an assembly language. The disassembly of the machine language occurs prior to the identification and replacement of the instruction in the binary code with the branch. Thus, the identification and replacement of the instruction in the binary code is performed on the assembly language representation of the binary code. The assembly language representation of the binary code, however, maintains a direct correspondence with the machine language representation of the binary code. This embodiment of the method also includes reassembling the assembly language representation of the binary code to represent the binary code in the machine language. The reassembling occurs after the instruction identification and replacement has been performed on the assembly language representation of the binary code.

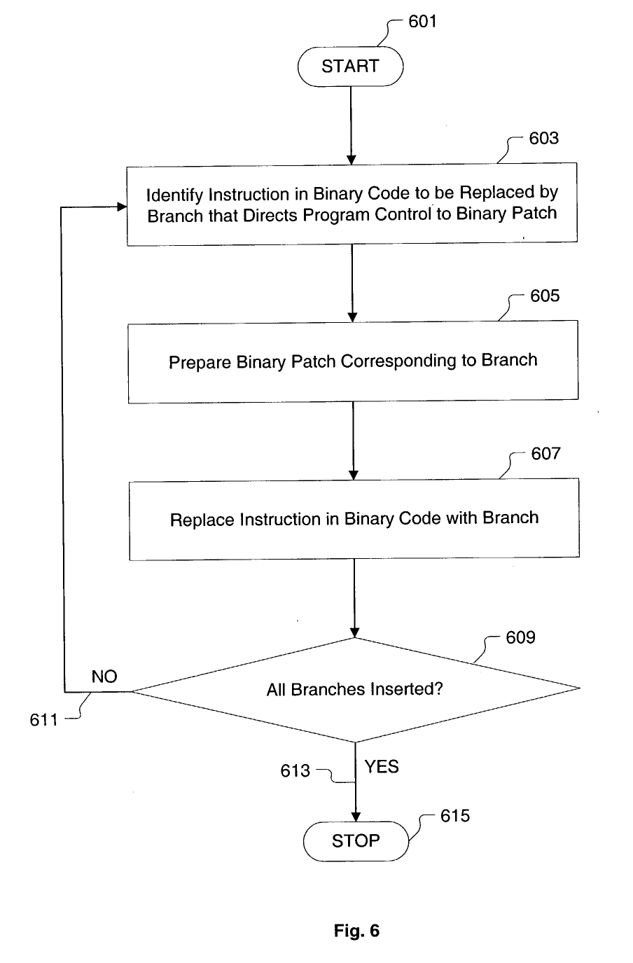

FIG. 6 shows a flowchart illustrating a method for inserting a binary patch into a binary code, in accordance with one embodiment of the present invention. The method begins at a start block 601. The method includes an operation 603 for identifying a first instruction in the binary code to be replaced by a branch, whereby the branch directs a program control to an initial instruction in the binary patch. The first instruction is one of a plurality of binary instructions included in the binary code. The plurality of binary instructions are executable by circuitry of a computer system. Thus, the binary code is represented using a machine language that is a native language for an architecture defining the circuitry of the computer system.

The method further includes an operation 605 for preparing the binary patch corresponding to the branch. The binary patch contains supplemental instructions to be included in the binary code. The initial instruction in the binary patch corresponds to the first instruction in the binary code to be replaced by the branch. A final instruction in the binary patch directs the program control to a second instruction in the binary code. The second instruction in the binary code immediately follows the first instruction in the binary code to be replaced by the branch.

The method further includes an operation 607 for replacing the first instruction in the binary code with the branch. Replacement of the first instruction in the binary code with the branch is performed without recompiling an original source code, wherein the original source code was used to create the binary code. The first instruction in the binary code is replaced by the branch while preserving a machine state that is present immediately prior to the replacement. The machine state includes the values associated with a plurality of registers and other data existing within the computer system.

The method includes a decision operation 609 for determining whether all branches have been inserted into the binary code. If the decision operation 609 determines that all branches have not been inserted into the binary code, the method loops back to the operation 603 for identifying the instruction in the binary code to be replaced by the branch, as indicated by an arrow 611. The method then continues through operations 605 and 607 until the decision operation 609 is reached again and reperformed. If the decision operation 609 determines that all branches have been inserted into the binary code, the method ends at a stop block 615, as indicated by an arrow 613.

In one embodiment, the method for inserting the binary patch into the binary code can be performed by disassembling the machine language to represent the binary code in an assembly language. The disassembly of the machine language occurs prior to the identification and replacement of the first instruction in the binary code with the branch. Thus, the identification and replacement of the first instruction in the binary code is performed on the assembly language representation of the binary code. The assembly language representation of the binary code, however, maintains a direct correspondence with the machine language representation of the binary code. This embodiment of the method also includes reassembling the assembly language representation of the binary code to represent the binary code in the machine language. The reassembling occurs after the first instruction has been identified and replaced using the assembly language representation of the binary code.

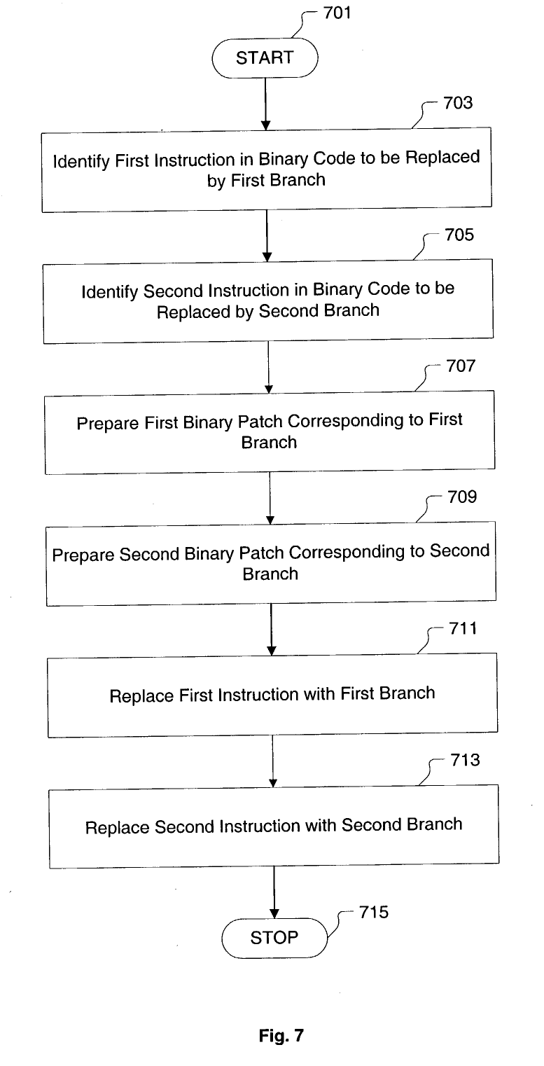

FIG. 7 shows a flowchart illustrating a method for inserting two binary patches into a binary code, in accordance with one embodiment of the present invention. The method begins at a start block 701. The method includes an operation 703 for identifying a first instruction in the binary code to be replaced by a first branch. The binary code includes a plurality of binary instructions that are executable by circuitry of a computer system. The first branch corresponds to a first binary patch. The first branch also directs a program control to an initial instruction in the first binary patch. The method further includes an operation 705 for identifying a second instruction in the binary code to be replaced by a second branch. The second instruction immediately follows the first instruction in the binary code. The second branch corresponds to a second binary patch.

The method further includes an operation 707 for preparing the first binary patch corresponding to the first branch. The first binary patch contains supplemental instructions to be included in the binary code. The initial instruction in the first binary patch is the first instruction in the binary code to be replaced by the first branch. A final instruction in the first binary patch directs the program control to an initial instruction in the second binary patch. The method further includes an operation 709 for preparing the second binary patch corresponding to the second branch. The second binary patch contains supplemental instructions to be included in the binary code. The initial instruction in the second binary patch is the second instruction in the binary code to be replaced by the second branch. A final instruction in the second binary patch directs the program control to an instruction in the binary code that immediately follows the second instruction in the binary code that was replaced by the second branch.

The method further includes an operation 711 for replacing the first instruction in the binary code with the first branch. The method further includes an operation 713 for replacing the second instruction in the binary code with the second branch. Replacement of the first and second instructions with the first and second branches, respectively, is performed without recompiling an original source code, wherein the original source code was used to create the binary code. Also, replacement of the first and second instructions with the first and second branches, respectively, is performed such that a machine state is preserved. The machine state includes the values associated with a plurality of registers and other data existing within the computer system. The machine state prior to execution of the first branch may differ from the machine state prior to execution of the second branch. The method ends at a stop block 715.

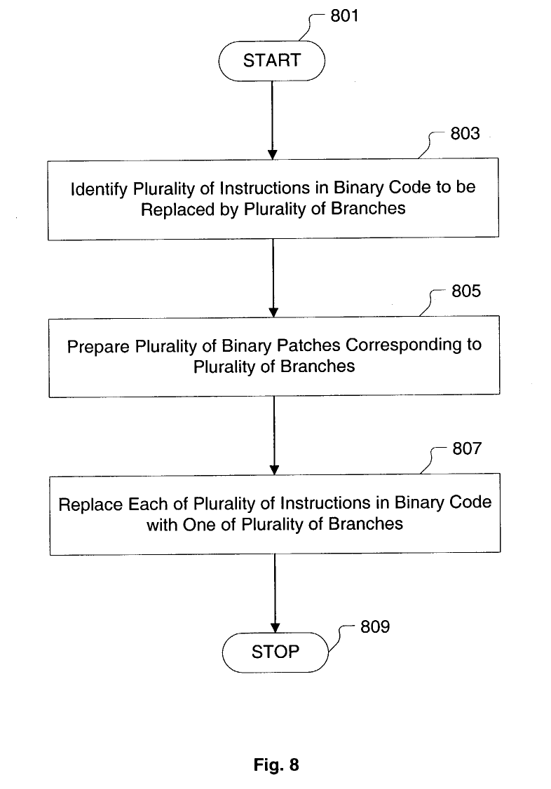

FIG. 8 shows a flowchart illustrating a method for inserting a plurality binary patches into a binary code, in accordance with one embodiment of the present invention. The method begins at a start block 801. The method includes an operation 803 for identifying a plurality of instructions in the binary code to be replaced by a plurality of branches. The plurality of instructions occur sequentially in the binary code and are executable by circuitry of a computer system. The plurality of branches correspond to the plurality of binary patches. A first instruction in the plurality of instructions directs a program control to an initial instruction in a first binary patch of the plurality of binary patches. The initial instruction in the first binary patch is the first instruction in the binary code to be replaced by the plurality of branches.

The method further includes an operation 805 for preparing the plurality of binary patches corresponding to the plurality of branches. The plurality of binary patches contain supplemental instructions to be included in the binary code. A final instruction in each of the plurality of binary patches directs the program control to an initial instruction in a subsequent binary patch. The initial instruction in a subsequent binary patch corresponds to a subsequent instruction in the binary code that is replaced by one of the plurality of branches. The last binary patch contains a final instruction that directs the program control to an instruction in the binary code that immediately follows the plurality of instructions replaced by the plurality of branches.

The method further includes an operation 807 for replacing each of the plurality of instructions in the binary code with one of the plurality of branches. Replacement of the plurality of instructions with the plurality branches s performed without recompiling an original source code, wherein the original source code was used to create the binary code. Also, replacement of the plurality of instructions with the plurality of branches is performed such that a machine state existing immediately prior to execution of each of the plurality of branches is preserved. The machine state includes the values associated with a plurality of registers and other data existing within the computer system. The method ends at a stop block 809.

Additionally, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

What is claimed is:

1. A method for editing a binary code, comprising:
preparing a binary patch, the binary patch containing supplemental instructions to be included in the binary code;
identifying an instruction in the binary code; and
replacing the instruction in the binary code with a branch, the branch directing a control of the binary code to the binary patch.

2. A method for editing a binary code as recited in claim 1, wherein a first instruction in the binary patch is the instruction in the binary code replaced with the branch.

3. A method for editing a binary code as recited in claim 1, wherein a last instruction in the binary patch directs the control of the binary code to a subsequent instruction in the binary code, the subsequent instruction immediately following the instruction in the binary code replaced with the branch.

4. A method for editing a binary code as recited in claim 1, wherein replacing the instruction in the binary code with the branch is performed without recompiling an original source code, the original source code having been used to create the binary code.

5. A method for editing a binary code as recited in claim 1, wherein the binary code is represented using a machine language, the machine language being a native language for a computer architecture.

6. A method for editing a binary code as recited in claim 5, further comprising:
disassembling the machine language to represent the binary code in an assembly language, the disassembling occurring prior to identifying the instruction in the binary code and replacing the instruction in the binary code with the branch, the instruction identification and replacement being performed on the assembly language representation of the binary code, the assembly language having a direct correspondence with the machine language.

7. A method for editing a binary code as recited in claim 6, further comprising:
reassembling the assembly language representation of the binary code to represent the binary code in the machine language, the reassembling occurring after the instruction identification and replacement having been performed on the assembly language representation of the binary code.

8. A method for editing a binary code as recited in claim 1, wherein replacing the instruction in the binary code with the branch is performed such that a machine state is preserved, the machine state comprising a plurality of register values and data existing immediately prior to an execution of the branch.

9. A method for editing a binary code as recited in claim 1, wherein the binary code comprises a plurality of binary instructions, the plurality of binary instructions being executable by computer system circuitry.

10. A method for inserting a binary patch into a binary code, comprising:
identifying a first instruction in the binary code to be replaced by a branch to the binary patch, the branch directing a program control to an initial instruction in the binary patch;
preparing the binary patch, the binary patch containing supplemental instructions to be included in the binary code, the initial instruction in the binary patch being the first instruction in the binary code to be replaced by the branch, a final instruction in the binary patch directing the program control to a second instruction in the binary code, the second instruction immediately following the first instruction in the binary code that is to be replaced by the branch; and
replacing the first instruction in the binary code with the branch.

11. A method for inserting a binary patch into a binary code as recited in claim 10, wherein replacing the first instruction in the binary code with the branch is performed without recompiling an original source code, the original source code having been used to create the binary code.

12. A method for inserting a binary patch into a binary code as recited in claim 10, wherein the binary code is represented using a machine language, the machine language being a native language for a computer architecture.

13. A method for inserting a binary patch into a binary code as recited in claim 12, further comprising:
disassembling the machine language to represent the binary code in an assembly language, the disassembling occurring prior to identifying the first instruction in the binary code and replacing the first instruction in the binary code with the branch, the first instruction identification and replacement being performed on the assembly language representation of the binary code, the assembly language having a direct correspondence with the machine language.

14. A method for inserting a binary patch into a binary code as recited in claim 13, further comprising:
reassembling the assembly language representation of the binary code to represent the binary code in the machine language, the reassembling occurring after the first instruction identification and replacement having been performed on the assembly language representation of the binary code.

15. A method for inserting a binary patch into a binary code as recited in claim 10, wherein replacing the first instruction in the binary code with the branch is performed such that a machine state is preserved, the machine state comprising a plurality of register values and data existing immediately prior to an execution of the branch.

16. A method for inserting a binary patch into a binary code as recited in claim 10, wherein the binary code comprises a plurality of binary instructions, the plurality of binary instructions being executable by computer system circuitry.

17. A method for inserting a plurality of binary patches into a binary code, comprising:
identifying a plurality of instructions in the binary code to be replaced by a plurality of branches, the plurality of instructions occurring sequentially in the binary code, the plurality of branches corresponding to the plurality of binary patches, a first instruction of the plurality of instructions directing a program control to an initial instruction in a first binary patch of the plurality of binary patches;
preparing the plurality of binary patches, wherein the plurality of binary patches contain supplemental instructions to be included in the binary code, the initial instruction in the first binary patch of the plurality of binary patches being the first instruction of the plurality of instructions in the binary code to be replaced by the plurality of branches, a final instruction in each of the plurality of binary patches directing the program control to an initial instruction in a subsequent binary patch of the plurality of binary patches, the initial instruction in a subsequent binary patch of the plurality of binary patches being a subsequent instruction of the plurality of instructions in the binary code to be replaced by the plurality of branches, a final instruction in a last binary patch of the plurality of binary patches directing the program control to an instruction in the binary code immediately following the plurality of instructions in the binary code to be replaced by the plurality of branches; and
replacing each of the plurality of instructions in the binary code with one of the plurality of branches.

18. A method for inserting a plurality of binary patches into a binary code as recited in claim 17, wherein replacing each of the plurality of instructions in the binary code with one of the plurality of branches is performed without recompiling an original source code, the original source code having been used to create the binary code.

19. A method for inserting a plurality of binary patches into a binary code as recited in claim 17, wherein replacing each of the plurality of instructions in the binary code with one of the plurality of branches is performed such that a machine state is preserved, the machine state comprising a plurality of register values and data existing immediately prior to an execution of each of the plurality of branches.

20. A method for inserting a plurality of binary patches into a binary code as recited in claim 17, wherein the binary code comprises a plurality of binary instructions, the plurality of binary instructions being executable by computer system circuitry.

21. A method for inserting two binary patches into a binary code, comprising:
identifying a first instruction in the binary code to be replaced by a first branch, the first branch corresponding to a first binary patch, the first branch directing a program control to an initial instruction in the first binary patch;
identifying a second instruction in the binary code to be replaced by a second branch, the second instruction immediately following the first instruction in the binary code, the second branch corresponding to a second binary patch;
preparing the first binary patch, wherein the first binary patch contains supplemental instructions to be included in the binary code, the initial instruction in the first binary patch being the first instruction in the binary code to be replaced by the first branch, a final instruction in the first binary patch directing the program control to an initial instruction in the second binary patch;
preparing the second binary patch, wherein the second binary patch contains supplemental instructions to be included in the binary code, the initial instruction in the second binary patch being the second instruction in the binary code to be replaced by the second branch, a final instruction in the second binary patch directing the program control to an instruction in the binary code immediately following the second instruction in the binary code to be replaced by the second branch;
replacing the first instruction in the binary code with the first branch; and
replacing the second instruction in the binary code with the second branch.

22. A method for inserting two binary patches into a binary code as recited in claim 21, wherein replacing the first instruction in the binary code with the first branch and replacing the second instruction in the binary code with the second branch is performed without recompiling an original source code, the original source code having been used to create the binary code.

23. A method for inserting two binary patches into a binary code as recited in claim 21, wherein replacing the first instruction in the binary code with the first branch and replacing the second instruction in the binary code with the second branch is performed such that a machine state is preserved, the machine state comprising a plurality of register values and data existing immediately prior to an execution of the first branch and the second branch, wherein the machine state immediately prior to the execution of the first branch may be different than the machine state immediately prior to the execution of the second branch.

24. A method for inserting two binary patches into a binary code as recited in claim 21, wherein the binary code comprises a plurality of binary instructions, the plurality of binary instructions being executable by computer system circuitry.
